(19) United States
(12) Patent Application Publication
(10) Pub. No.: US 2015/0271202 A1
(43) Pub. Date: Sep. 24, 2015

(54) METHOD, DEVICE, AND SYSTEM FOR DETECTING LINK LAYER HIJACKING, USER EQUIPMENT, AND ANALYZING SERVER

(71) Applicant: Tencent Technology (Shenzhen) Company Limited, Shenzhen (CN)

(72) Inventors: Shuaishuai YAN, Shenzhen (CN); Xijun LUO, Shenzhen (CN)

(73) Assignee: Tencent Technology (Shenzhen) Company Limited, Shenzhen (CN)

(21) Appl. No.: 14/720,400

(22) Filed: May 22, 2015

Related U.S. Application Data
(63) Continuation of application No. PCT/CN2014/080304, filed on Jun. 19, 2014.

(30) Foreign Application Priority Data
Jul. 31, 2013 (CN) 201310330142.X

(51) Int. Cl. H04L 29/06; G06F 17/30; H04L 29/08

(52) U.S. Cl. CPC H04L 63/1466; H04L 67/02; G06F 17/30887; H04L 63/1408; H04L 63/101

(57) ABSTRACT

A method for detecting a link layer hijacking includes: requesting web page information to a HTTP server; receiving from the HTTP server the web page information and a monitoring script preset on the HTTP server; sending information related to URL in the received web page information to an analyzing server based on the monitoring script; and parsing, by the analyzing server, URL text information from the information related to the URL and determining, by the analyzing server, whether the link layer hijacking occurs in the received web page information based on the URL text information. Thus, the precision of analysis of the link layer hijacking is improved, the number of missed link layer hijackings is reduced, and the effect for detecting the link layer hijacking is improved.

This application is a continuation of PCT international application PCT/CN2014/080304, filed on Jun. 19, 2014 which claims priority to Chinese Patent Application No. 201310330142.X, entitled “METHOD, DEVICE, AND SYSTEM FOR DETECTING LINK LAYER HIJACKING, USER EQUIPMENT, AND ANALYZING SERVER”, filed with the Chinese Patent Office on Jul. 31, 2013, both of which are hereby incorporated by reference in their entireties.

### FIELD

The disclosure relates to the field of information security technology, and in particular to a method, a device and a system for detecting a link layer hijacking, a user equipment, and an analyzing server.

### BACKGROUND

Link layer hijacking refers to a means for inserting malicious codes or Uniform Resource Locators (URL) into a web page on a network transmission physical link, to steal user information. Because of a security danger of leaking user information due to the link layer hijacking, it is necessary to detect the link layer hijacking, thereby to determine whether there are malicious codes or URLs in a web page requested by a user.

An existing method for detecting a link layer hijacking in a web page includes: providing a detecting device at a bypass in the link to detect the link layer hijacking for a web page, where the detecting device is adapted to determine whether the link layer hijacking occurs in a returned page based on page information obtained and returned to a user. FIG. 1 is a diagram showing a network topology of a system for detecting a link layer hijacking in the conventional technology. Referring to FIG. 1, the procedure for detecting a link layer hijacking in the conventional technology includes: sending, by user equipment, a GET/POST request (which is a request in http protocol, where GET is configured to obtain data from a server, and POST is configured to send data to a server) to a sever; replying, by the server, response information to the user based on a type of the request; mirroring the response information by a detecting device to obtain a copy of the information replied by the server, parsing a URL from the copy, compares the parsed URL with a preset white list of URLs, and identifies a malicious URL and a page with the link layer hijacking.

In the conventional technology, there are at least the following technique problems. The detecting device provided at the bypass additionally has a detecting effect limited by a location thereof. The closer the detecting device to the user equipment, the better the effect for detecting the link layer hijacking. However, the detecting device is generally close to a server, and it is difficult to provide the detecting device close to the user equipment. Thus, the possibility for the link layer hijacking on the transmission link between the detecting device and the user equipment is increased. Therefore, the precision for detecting the link layer hijacking is lowered. In addition, the link layer hijacking may be missed, so that the effect for detecting the link layer hijacking is lowered.

### SUMMARY

In view of the above, a method for detecting a link layer hijacking, a device for detecting a link layer hijacking, a user equipment, an analyzing server and a system for detecting a link layer hijacking are provided according to embodiments of the disclosure, to resolve the problems in the conventional technology that the effect for detecting the link layer hijacking is affected by the location of the detecting device provided additionally, and thus the precision of an analysis of the link layer hijacking is lowered; and the effect for detecting the link layer hijacking is lowered because the link layer hijacking may be missed.

In a first aspect, a method for detecting a link layer hijacking is provided, which is applied to user equipment. The method includes: requesting web page information to a Hypertext Transfer Protocol (HTTP) server; receiving from the HTTP server the web page information and a monitoring script preset on the HTTP server; sending, to an analyzing server, information related to Uniform Resource Locator (URL) in the received web page information based on the monitoring script; and parsing, by the analyzing server, URL text information from the information related to the URL; and determining, by the analyzing server, whether the link layer hijacking occurs in the received web page information based on the URL text information.

In a second aspect, a method for detecting a link layer hijacking is further provided, which is applied to an analyzing server. The method includes: receiving information related to Uniform Resource Locator (URL) in web page information after user equipment receives from a Hypertext Transfer Protocol (HTTP) server the web page information and the monitoring script preset on the HTTP server, where the information related to the URL is sent by the user equipment based on a monitoring script; parsing URL text information from the information related to the URL; and determining whether the link layer hijacking occurs in the received web page information based on the URL text information.

In a third aspect, a device for detecting a link layer hijacking is further provided. The device may be included in a user equipment. The device includes a processor and a non-transitory storage accessible to the processor. The device is configured to: request web page information to a Hypertext Transfer Protocol (HTTP) server; receive from the HTTP server the web page information and a monitoring script preset on the HTTP server that are returned; and send to an analyzing server information related to Uniform Resource Locator (URL) in the received web page information based on the monitoring script, wherein the analyzing server parses URL text information from the information related to the URL and determines whether the link layer hijacking occurs in the received web page information based on the URL text information.

In a fourth aspect, a device for detecting a link layer hijacking is further provided. The device may be applied to an analyzing server and includes: a second receiving module configured to receive information related to Uniform Resource Locator (URL) in web page information, after user equipment receives from a Hypertext Transfer Protocol (HTTP) server the web page information and the monitoring script preset on the HTTP server, wherein the information related to the URL is sent by the user equipment based on a monitoring script; a parsing module configured to parse URL text information from the information related to the URL; and an identifying module configured to determine whether the link layer hijacking occurs in the received web page information based on the URL text information.

In a fifth aspect, a system for detecting a link layer hijacking is further provided. The system includes a Hypertext Transfer Protocol (HTTP) server, user equipment and an analyzing server, the HTTP server is configured to preset a monitoring script, and reply web page information and the monitoring script to the user equipment in response to the request of the user equipment for the web page information; the user equipment is configured to request the web page information to the HTTP server, receive from the HTTP server the web page information and the monitoring script, and send to the analyzing server information related to Uniform Resource Locator (URL) in the received web page information based on the monitoring script; and the analyzing server is configured to parse URL text information from the information related to the URL and determine whether the link layer hijacking occurs in the received web page information based on the URL text information.

### BRIEF DESCRIPTION OF THE DRAWINGS

The accompanying drawings applied to the description of the embodiments or the existing technologies will be described briefly as follows, to clarify the technical solutions according to the embodiments of the disclosure or the existing technologies. It is obvious that the accompanying drawings in the following description are only some embodiments of the disclosure. For those skilled in the art, other accompanying drawings may be obtained according to these accompanying drawings without any creative work.

FIG. 1 is a diagram showing a network topology of a system for detecting a link layer hijacking in the conventional technology;

FIG. 2 is a flowchart of a method for detecting a link layer hijacking according to embodiments of the disclosure;

FIG. 3 is another flowchart of a method for detecting a link layer hijacking according to embodiments of the disclosure;

FIG. 4 is a flowchart of a method for determining a link layer hijacking in received web page information according to embodiments of the disclosure;

FIG. 5 is a flowchart of a method for determining a malicious hijacking according to embodiments of the disclosure;

FIG. 6 is yet another flowchart of a method for detecting a link layer hijacking according to embodiments of the disclosure;

FIG. 7 is a block diagram showing a structure of a device for detecting a link layer hijacking according to embodiments of the disclosure;

FIG. 8 is a block diagram showing another structure of a device for detecting a link layer hijacking according to embodiments of the disclosure;

FIG. 9 is a block diagram showing a structure of a parsing module according to embodiments of the disclosure;

FIG. 10 is a block diagram showing a structure of an identifying module according to embodiments of the disclosure;

FIG. 11 is a block diagram showing another structure of a device for detecting a link layer hijacking according to embodiments of the disclosure;

FIG. 12 is a block diagram of yet another structure of a device for detecting a link layer hijacking according to embodiments of the disclosure;

FIG. 13 is a block diagram showing a structure of a system for detecting a link layer hijacking according to embodiments of the disclosure;

FIG. 14 is a diagram showing a hardware structure of user equipment according to embodiments of the disclosure; and

FIG. 15 is a diagram showing a hardware structure of an analyzing server according to embodiments of the disclosure.

### DETAILED DESCRIPTION OF EMBODIMENTS

In order to make the object, technical solution and advantage according to the embodiments of the disclosure more clear, the technical solution according to the embodiments of the disclosure will be described clearly and completely as follows in conjunction with the accompanying drawings in the embodiments of the disclosure. It is obvious that the described embodiments are only a part of the embodiments according to the disclosure. All the other embodiments obtained by those skilled in the art based on the embodiments in the disclosure without any creative work belong to the scope of the disclosure.

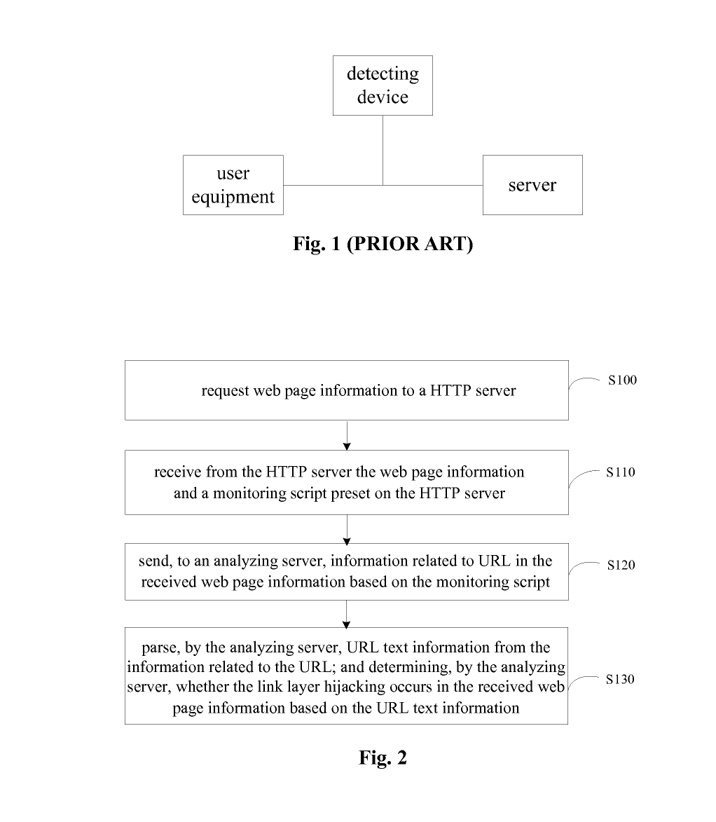

FIG. 2 is a flowchart of a method for detecting a link layer hijacking according to embodiments of the disclosure. The method is applied to user equipment, which is performed at a user side. Referring to FIG. 2, the method may include steps S100 to S130 as follows.

Step S100 includes: requesting web page information to a Hypertext Transfer Protocol (HTTP) server.

The user equipment may send a GET/POST request to the HTTP server, to obtain the requested web page information from the HTTP server.

Step S110 includes: receiving from the HTTP server the web page information and a monitoring script preset on the HTTP server.

The monitoring script may be a monitoring script in JavaScript (JS). JavaScript is a prototype-based and object-oriented case sensitive client-side script language with dynamic typing and developed from LiveScript of Netscape.

In an embodiment, the JS monitoring script may be preset on an HTTP server to be monitored. The JS monitoring script may be downloaded to the user equipment when the HTTP server replies the web page information to the user equipment. For example, if a web site www.qq.com needs to be monitored to detect a link layer hijacking in an embodiment, an HTTP server corresponding to the web set www.qq.com is preset with a JS script. When the user equipment requests a web page information of the web site www.qq.com to the HTTP server corresponding to the web set www.qq.com, the HTTP server replies the web page information of the web site www.qq.com as well as the JS preset script to the user equipment.

Step S120 includes: sending, to an analyzing server, information related to Uniform Resource Locator (URL) in the received web page information to an analyzing server based on the monitoring script.

Step S130 includes: parsing, by the analyzing server, URL text information from the information related to the URL; and determining, by the analyzing server, whether the link layer hijacking occurs in the received web page information based on the URL text information.

After receiving the web page information and the JS monitoring script, the user equipment is not able to determine whether the link layer hijacking occurs in the received web page information or whether malicious codes and URLs are inserted in the received web page information. The user equipment sends, to the analyzing server at a network side, information related to the URL in the received web page information based on the received monitoring script. The analyzing server parses URL text information from the information related to the URL after receiving the information related to the URL; and identifies a state of the link layer hijacking of the received web page information based on the URL text information. Here, the state of the link layer hijacking means that the link layer hijacking does or does not occur in the received web page information.

It needs to be noted that the monitoring script is set on the HTTP server corresponding to the site to be monitored in the embodiment. Thus, the monitoring script will be provided to the user equipment together with the web page information, only when the user equipment requests the web page information to the HTTP server. After receiving the monitoring script, the user equipment may know that the web site corresponding to the requested web page information needs to be monitored, and may send information related to the URL in the received web page information to the analyzing server based on the monitoring script. The analyzing server determines whether the link layer hijacking occurs in the received web page information. In the embodiment, the monitoring script is mainly configured to trigger the user equipment to report to the analyzing server the information related to the URL in the received web page information.

In the method for detecting the link layer hijacking according to the embodiment, the user equipment requests the web page information to an HTTP server, receives from the HTTP server the web page information and the monitoring script preset on the HTTP server, and sends the information related to the URL in the received web page information to an analyzing server based on the monitoring script. The analyzing server parses URL text information from the information related to the URL, and determines whether the link layer hijacking occurs in the received web page information based on the URL text information. In the embodiment, the detection of the link layer hijacking does not depend on a detecting device provided at a bypass additionally, thus the detection effect is not affected by the location of the detecting device provided at the bypass additionally. In the embodiments, the analyzing server is configured to determine a state of the link layer hijacking by analyzing the URL text information, i.e., is the URL text information in the web page information received by the user equipment. In this way, the precision of the analysis of the link layer hijacking is improved, the number of missed link layer hijacks is reduced, and the effect for detecting the link layer hijacking is improved.

Optionally, the information related to the URL may include text information in the received web page information, and/or JS information obtained from the received web page information.

The URL text information refers to a file for indicating URL carried in the web page information. Thus, the state of the link layer hijacking of the received web page information may be identified based on the URL text information. The URL mainly includes: URL in text-type (mainly for static web page) and ULR packed by JS arithmetic, i.e., URL nested by a dynamic JS arithmetic (mainly for dynamic web page). The user equipment may send the information related to the URL to the analyzing server by three ways. In the first way, the user equipment may send text information in the received web page information to the analyzing server. In the second way, the user equipment may send JS information obtained from the received web page information to the analyzing server. In the third way, the user equipment may send to the analyzing server both the text information in the received web page information and the JS information obtained from the received web page information.

In the case that the user equipment send the text information in the received web page information to the analyzing server, the analyzing server may extract URL text information from the text information based on a URL key word. The URL key word mainly includes some key words related to the URL, such as frame, iframe, script, and form.

In the case that the user equipment sends the JS information obtained from the received web page information to the analyzing server, the analyzing server may extract the nested URL text information from the JS information by a preset JS monitoring engine. The preset JS monitoring engine may be spidermonkey engine.

A method for detecting a link layer hijacking according to an example embodiment will be described below with respect to an analyzing server. The method to be described below corresponds to the method described with respect to the user equipment, which may be referred to the method with respect to the user equipment.

FIG. 3 is another flowchart of a method for detecting a link layer hijacking according to embodiments of the disclosure. The method is applied to an analyzing server. The analyzing server is a server provided at the network side and configured to process data and logic operations. A data communication is provided between the analyzing server and the user equipment. Referring to FIG. 3, the method may include steps S200 to S220.

Step S200 may include: receiving information related to URL in web page information, where the information related to the URL is sent by user equipment based on a monitoring script, after the user equipment receives from a HTTP server the web page information and the monitoring script preset on the HTTP server.

Step S210 may include: parsing URL text information from the information related to the URL.

Step S220 may include: determining whether the link layer hijacking occurs in the received web page information based on the URL text information.

In the method for detecting the link layer hijacking according to the embodiment, the detection of a link layer hijacking does not depend on a detecting device provided at a bypass additionally, thus the detection effect is not affected by the location of the detecting device provided at the bypass additionally. In the embodiments, the analyzing server is configured to determine a state of the link layer hijacking by analyzing the URL text information, i.e., the URL text information in the web page information received by the user equipment. In this way, the precision of the analysis of the link layer hijacking is improved, the number of missed link layer hijackings is reduced, and the effect for detecting the link layer hijacking is improved.

Optionally, the information related to the URL may include text information in the received web page information, and/or JS information obtained from the received web page information.

In the case that the information related to the URL includes the text information, the analyzing server may extract the URL text information from the text information based on a URL key word. The URL key word may includes some key words related to the URL, such as frame, iframe, script, and form.

In the case that the information related to the URL includes the JS information, the analyzing server may extract the URL text information nested into the JS information by a preset JS monitoring engine. The preset JS monitoring engine may be spidermonkey engine.

In the embodiment, the URL text information of both static web page and dynamic web page may be extracted. Therefore, the method for detecting the link layer hijacking may be applied to more types of web page, the number of missed link layer hijackings is reduced, and the effect for detecting the link layer hijacking is improved.

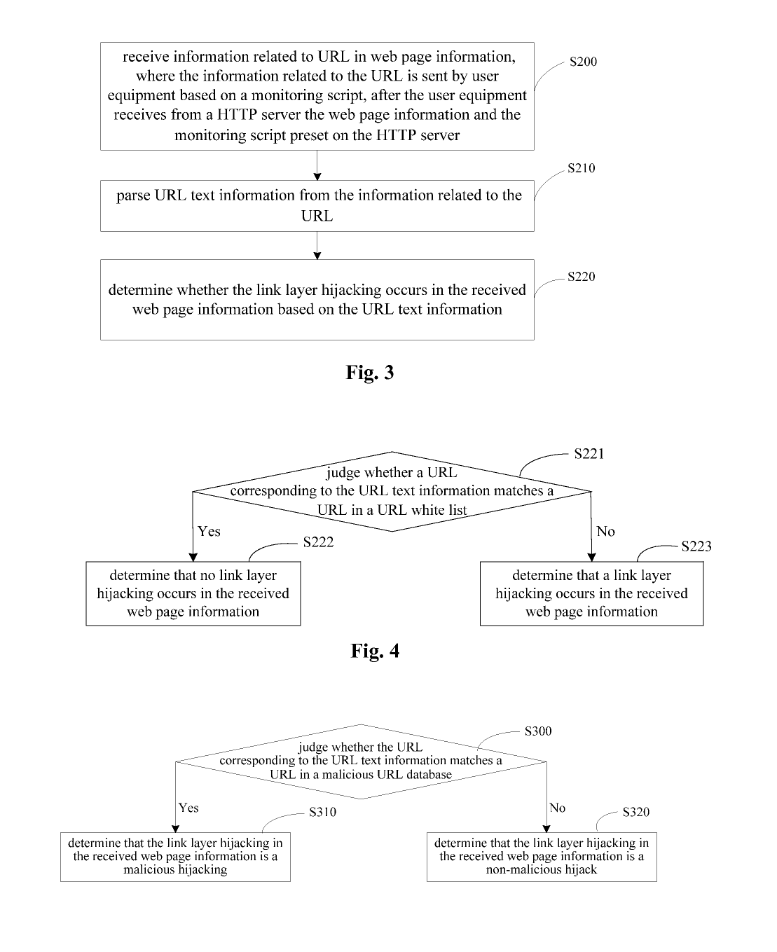

FIG. 4 is a flowchart of a method for determining a link layer hijacking in received web page information. The method may include steps S221 to S223.

Step S221 may include: determining whether a URL corresponding to the URL text information matches a URL in a URL white list; if the URL corresponding to the URL text information matches the URL in the URL white list, performing step S222; otherwise, performing step S223.

Step S222 may include: determining that no link layer hijacking occurs in the received web page information.

Step S223 may include: determining that a link layer hijacking occurs in the received web page information.

The method shown in FIG. 4 may be considered as an optional implementation for the step S220 in FIG. 3.

The link layer hijacking includes non-malicious hijacking and malicious hijacking. The non-malicious hijacking refers to some action with a low risk, such as an insertion of an advertisement page. The malicious hijacking includes some action such as an insertion of a code or a URL for stealing user's identity information. Therefore, in the embodiment, after determining the link layer hijacking in the web page information received by the user equipment, the method further includes: determining whether the link layer hijacking is a malicious hijacking. Referring to FIG. 5, the method for determining the malicious hijacking according to an embodiment includes steps S300 to S320.

Step S300 may include: determining whether the URL corresponding to the URL text information matches a URL in a malicious URL database; if the URL corresponding to the URL text information matches the URL in the malicious URL database, performing step S310; otherwise, performing step S320.

Step S310 may include: determining that the link layer hijacking in the received web page information is a malicious hijacking.

Step S223 may include: determining that the link layer hijacking in the received web page information is a non-malicious hijacking.

Optionally, after determining the link layer hijacking in the received web page information, the method includes: determining a source of the link layer hijacking, to make a statistic of the sources of link layer hijackings. In a particular implementation, the source of a link layer hijacking may be determined based on a user's Internet Protocol (IP) and a service identifier.

Optionally, the analyzing server may further output warning information after determining that the link layer hijacking in the web page information received by the user equipment. The warning information may be output to either the user equipment or the HTTP server corresponding to the site expected to be monitored. The step of outputting the warning to the user equipment may include: outputting first warning information to the user equipment based on region information of the user's IP and region information of Internet Server Provider (ISP). In an embodiment, the first warning information may be grouped based on the region information of IP region and the region information of ISP for output. The step of outputting the warning to the http server may include: outputting second warning information to the HTTP server corresponding to the web page, in the case that times the web page suffers from the link layer hijacking exceeds a threshold. For example, if the analyzing server finds that the times the web page www.qq.com suffers from the link layer hijacking exceeds a threshold, the analyzing server sends the second warning information to the HTTP server corresponding to www.qq.com, to alter web site operators.

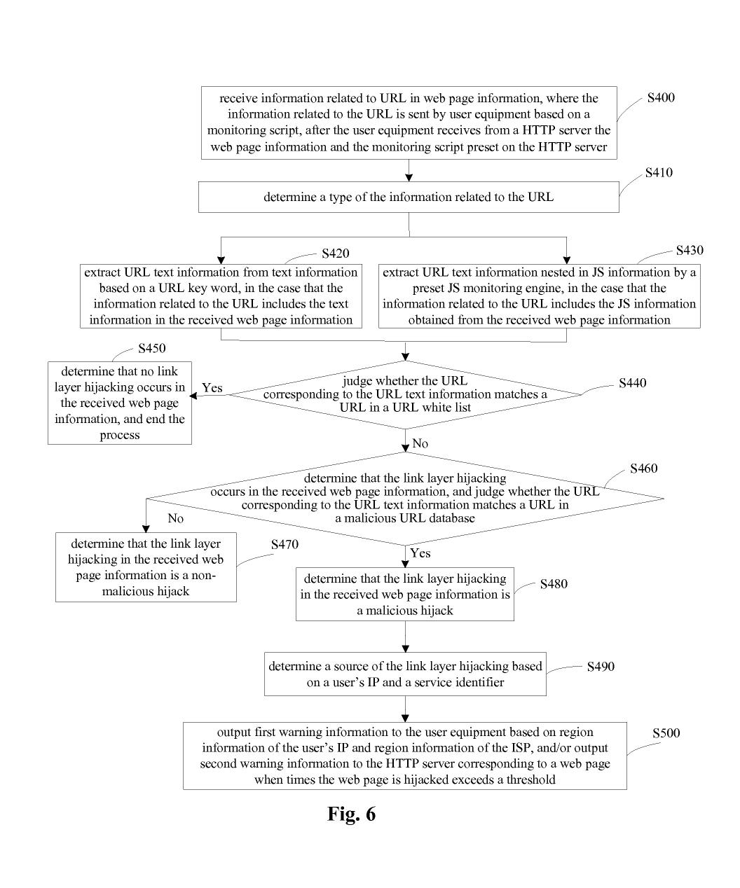

A method for detecting a link layer hijacking is provided below. FIG. 6 is yet another flowchart of a method for detecting a link layer hijacking according to embodiments of the disclosure. Referring to FIG. 6, the method may include steps S400 to S500.

Step S400 may include: receiving information related to URL in web page information, where the information related to the URL is sent by user equipment based on a monitoring script, after the user equipment receives from a HTTP server the web page information and the monitoring script preset on the HTTP server.

Step S410 may include: determining a type of the information related to the URL.

Step S420 may include: extracting URL text information from text information based on a URL key word, in the case that the information related to the URL includes the text information in the received web page information.

Step S430 may include: extracting URL text information nested in JS information by a preset JS monitoring engine, in the case that the information related to the URL includes the JS information obtained from the received web page information.

It should be noted that steps S420 and S430 are different processes for different types of information related to the URL after step S410.

Step S440 may include: determining whether the URL corresponding to the URL text information matches a URL in a URL white list; if the URL corresponding to the URL text information matches the URL in the URL white list, performing step S450; otherwise, performing step S465.

Step S450 may include: determining that no link layer hijacking occurs in the received web page information, and ending the process.

Step S460 may include: determining that the link layer hijacking occurs in the received web page information; determining whether the URL corresponding to the URL text information matches a URL in a malicious URL database, if the URL corresponding to the URL text information does not match any URLs in the malicious URL database, performing step S470; otherwise, performing step S480.

Step S470 may include: determining that the link layer hijacking in the received web page information is a non-malicious hijack.

Step S480 may include: determining that the link layer hijacking in the received web page information is a malicious hijack.

Step S490 may include: determining a source of the link layer hijacking based on a user's IP and a service identifier.

Step S500 may include: outputting first warning information to the user equipment based on region information of the user's IP and region information of Internet Server Provider (ISP), and/or outputting second warning information to the HTTP server corresponding to a web page when the times the web page is hijacked exceeds a threshold.

A device for detecting a link layer hijacking according to embodiments of the disclosure is described below with respect to user equipment. The device for detecting the link layer hijacking described below corresponds to the method for detecting the link layer hijacking described above with respect to user equipment, which may be referred to the method for detecting the link layer hijacking with respect to user equipment.

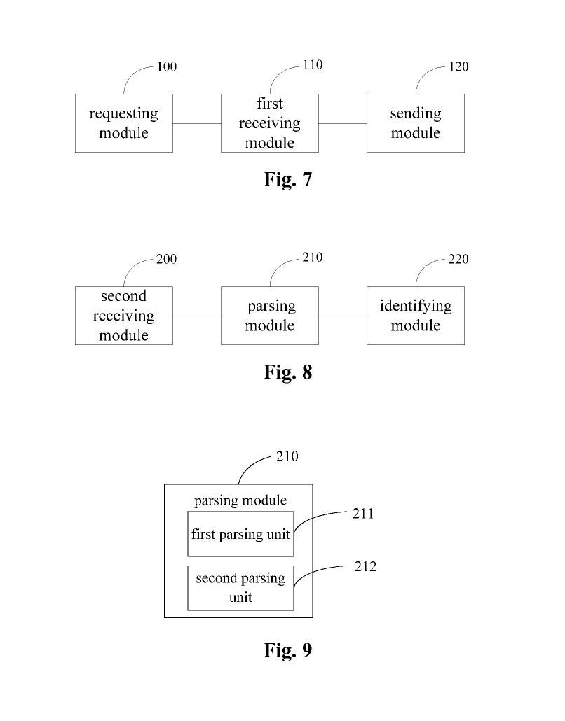

FIG. 7 is a block diagram showing a structure of a device for detecting a link layer hijacking according to the embodiment. Referring to FIG. 7, the device may include: a requesting module 100, a first receiving module 110 and a sending module 120.

The requesting module 100 is configured to request web page information to an HTTP server.

The first receiving module 110 is configured to receive from the HTTP server the web page information and a monitoring script preset on the HTTP server.

The sending module 120 is configured to send to an analyzing server information related to URL in the received web page information based on the monitoring script, where the analyzing server parses URL text information from the information related to the URL and determine whether the link layer hijacking occurs in the received web page information based on the URL text information.

With the device for detecting the link layer hijacking according to the embodiment, the detection of the link layer hijacking does not depend on a detecting device provided at a bypass additionally, thus the detection effect is not affected by the location of the detecting device provided at the bypass additionally. In the embodiments, the analyzing server is configured to determine a state of the link layer hijacking by analyzing the URL text information, i.e., the URL text information in the web page information received by the user equipment. In this way, the precision of the analysis of the link layer hijacking is improved, the number of missed link layer hijackings is reduced, and the effect for detecting the link layer hijacking is improved.

Optionally, the information related to the URL may include text information in the received web page information, and/or JS information obtained from the received web page information.

According to embodiments of the disclosure, user equipment is further provided, which includes the device for detecting the link layer hijacking described above with respect to the user equipment.

A device for detecting a link layer hijacking according to embodiments of the disclosure is described below with respect to an analyzing server. The device for detecting the link layer hijacking described below corresponds to the method for detecting the link layer hijacking described above with respect to the analyzing server, which may be referred to the method for detecting the link layer hijacking with respect to the analyzing server.

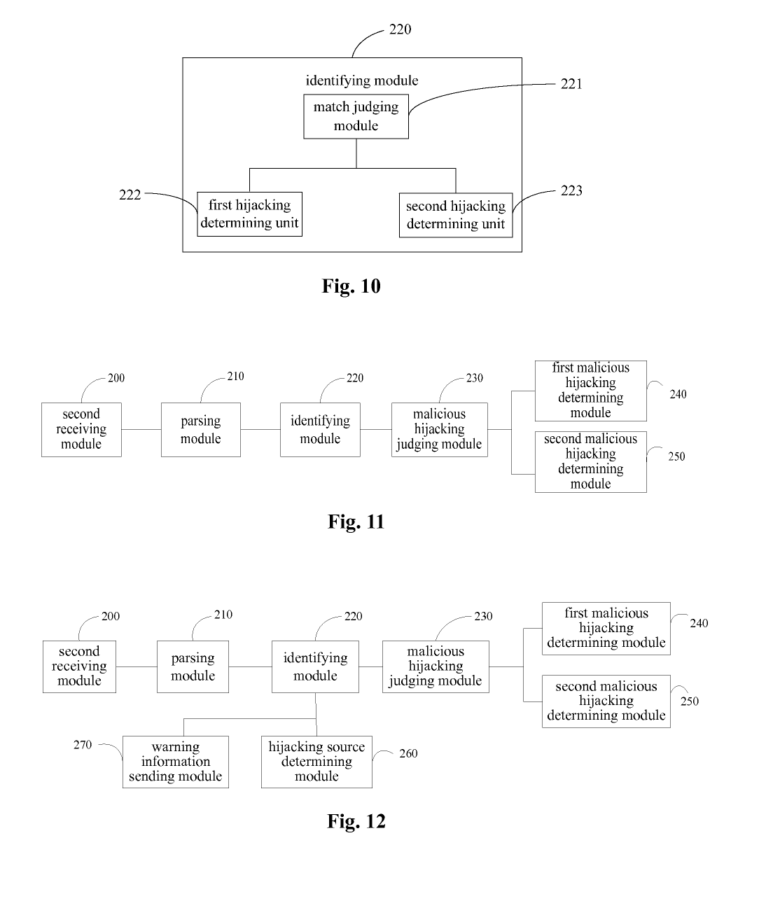

FIG. 8 is a block diagram showing another structure of a device for detecting a link layer hijacking according to the embodiment. The device for detecting the link layer hijacking is applied to an analyzing server. Referring to FIG. 8, the device may include: a second receiving module 200, a parsing module 210, and an identifying module 220.

The second receiving module 200 is configured to receive information related to URL in web page information, where the information related to the URL is sent by user equipment based on a monitoring script, after the user equipment receives from a HTTP server the web page information and the monitoring script preset on the HTTP server.

The parsing module 210 is configured to parse URL text information from the information related to the URL.

The identifying module 220 is configured to determine whether the link layer hijacking occurs in the received web page information based on the URL text information.

In the embodiment, the analyzing server is configured to analyze the URL text information, i.e., the URL text information in the web page information received by the user equipment, to determine a state of the link layer hijacking. In this way, the precision of an analysis of the link layer hijacking is improved, the number of missed link layer hijackings is reduced, and the effect for detecting the link layer hijacking is improved.

Optionally, the information related to the URL may include text information in the received web page information, and/or JS information obtained from the received web page information. Correspondingly, the parsing module 210 may have a structure shown in FIG. 9. Referring to FIG. 9, the parsing module 210 may include: a first parsing unit 211 and a second parsing unit 212.

The first parsing unit 211 is configured to extract URL text information from the information related to the URL based on a URL key word, in the case that the information related to the URL includes the text information in the received web page information.

The second parsing unit 212 is configured to extract URL text information nested in JS information by a preset JS monitoring engine, in the case that the information related to the URL includes the JS information obtained from the received web page information.

FIG. 10 is a block diagram showing a structure of the identifying module 220 according to embodiments of the disclosure. Referring to FIG. 10, the identifying module 220 may include: a match determining unit 221, a first hijacking determining unit 222 and a second hijacking determining unit 223

The match determining unit 221 is configured to determine whether the URL corresponding to the URL text information matches a URL in a URL white list.

The first hijacking determining unit 222 is configured to determine that no link layer hijacking occurs in the received web page information, if the URL corresponding to the URL text information matches the URL in the URL white list.

The second hijacking determining unit 223 is configured to determine that the link layer hijacking occurs in the received web page information, if the URL corresponding to the URL text information does not match any URLs in the URL white list.

The device for detecting the link layer hijacking may have another structure according to embodiments of the disclosure. FIG. 11 is a block diagram showing another structure of a device for detecting a link layer hijacking according to embodiments of the disclosure. This device differs from the device for detecting the link layer hijacking in FIG. 8 in that this device may further include: a malicious hijacking determining module 230, a first malicious hijacking determining module 240, and a second malicious hijacking determining module 250.

The malicious hijacking determining module 230 is configured to determine whether the URL corresponding to the URL text information matches a URL in a malicious URL database, after it is determined that the link layer hijacking occurs in the received web page information.

The first malicious hijacking determining module 240 is configured to determine that the link layer hijacking in the received web page information is a malicious hijack, if the URL corresponding to the URL text information matches the URL in the malicious URL database; and

The second malicious hijacking determining module 250 is configured to determine that the link layer hijacking in the received web page information is a non-malicious hijack, if the URL corresponding to the URL text information does not match any URLs in the malicious URL database;

FIG. 12 is a block diagram showing yet another structure of a device for detecting a link layer hijacking according to embodiments of the disclosure. This device differs from the device for detecting the link layer hijacking in FIG. 11 in that this device may further include: a hijacking source determining module 260 and a warning information sending module 270.

The hijacking source determining module 260 is configured to determine a source of the link layer hijacking based on a user's IP and a service identifier, after it is determined that the link layer hijacking occurs in the received web page information.

The warning information sending module 270 is configured to output first warning information to the user equipment based on region information of the user's IP and region information of Internet Server Provider (ISP), after it is determined that a link layer hijacking occurs in the received web page information; and/or output second warning information to the HTTP server corresponding to the web page in the case that times the web page is hijacked exceeds a threshold.

According to embodiments of the disclosure, an analyzing server is further provided, which includes the device for detecting the link layer hijacking described above with respect to an analyzing server.

A system for detecting a link layer hijacking according to embodiments of the disclosure is described below. The system for detecting the link layer hijacking described below corresponds to the method and device for detecting the link layer hijacking described above with respect to user equipment and an analyzing server, which may be referred to them.

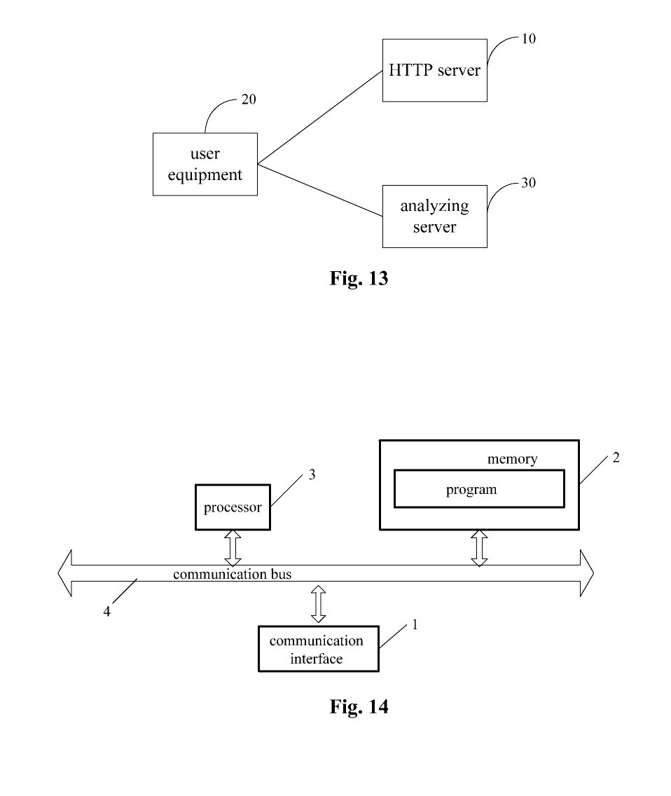

FIG. 13 is a block diagram showing a structure of a system for detecting a link layer hijacking according to embodiments of the disclosure. Referring to FIG. 13, the system for detecting the link layer hijacking may include an HTTP server 10, user equipment 20 and an analyzing server 30.

The HTTP server 10 is configured to preset a monitoring script, and reply web page information and the monitoring script to the user equipment in response to the request of the user equipment 20 for the web page information.

The user equipment 20 is configured to request the web page information to the HTTP server 10, receive from the HTTP server the web page information and the monitoring script, and send to the analyzing server 30 information related to URL in the received web page information based on the monitoring script.

The analyzing server 30 is configured to parse URL text information from the information related to the URL and determine whether the link layer hijacking occurs in the received web page information based on the URL text information.

In the system for detecting the link layer hijacking according to the embodiment, a monitoring script is preset at an HTTP server. When the user equipment requests web page information, the user equipment receives from the HTTP server the web page information and the monitoring script preset on the HTTP server, and sends information related to the URL in the received web page information to the analyzing server based on the monitoring script. The analyzing server parses URL text information from the information related to URL, and determines whether the link layer hijacking occurs in the received web page information based on the URL text information. In the embodiment, the detection of the link layer hijacking does not depend on a detecting device provided at a bypass additionally, thus the detection effect is not affected by the location of the detecting device provided at the bypass additionally. In the embodiments, the analyzing server is configured to determine a state of the link layer hijacking by analyzing the URL text information, i.e., the URL text information in the web page information received by the user equipment. In this way, the precision of the analysis of the link layer hijacking is improved, the number of missed link layer hijacks is reduced, and the effect for detecting the link layer hijacking is improved.

In the following, a hardware structure of user equipment is described according to embodiments of the disclosure. FIG. 14 is a diagram showing a hardware structure of user equipment according to embodiments of the disclosure. Referring to FIG. 14, the user equipment may include a communication interface 1, a memory 2, a processor 3 and a communication bus 4.

Components of the user equipment are described in detail in conjunction with FIG. 14.

A communication interface 1 may be an interface of a communication module, such as an interface of a network card, which is configured to receive and transmit signals between an access server and peripheral equipment.

A memory 2 may be configured to store software programs and modules. A processor 3 performs various function applications and data processes in the access server by running the software programs and modules stored in the memory 2. The memory 2 may mainly include a storage region for program and a storage region for data. The storage region for program may store operating system, application needed by at least one function (such as an audio playing function, a video playing function) and the like. The storage region for data may store data (such as video data, an address book) generated by using the access server and the like. Furthermore, the memory 2 may include a high speed random access memory and may further include a non-volatile storage, such as at least one of a disk storage device, a flash memory or other non-volatile solid-state storage device.

The processor 3 is a control center of the access server, which is connected to various components of the access server through various interfaces and lines. The processor 3 performs various functions and data processes by executing or running the software programs and modules stored in the memory 2 and calling the data stored in the memory 2, thereby monitoring the access server. Optionally, the process 3 may include one or more processing unit. Preferably, an application processor and a modem may be integrated into the processor 3, in which the application processor is applied to the operating system and applications, and the modem is applied to a wireless communication. It can be understood that the above modem may further not be integrated into the process 3.

The communication 1, the memory 2 and the processor 3 communicate with each other through a communication bus 4.

In embodiments of the disclosure, the processor 3 may further have the following functions:

requesting web page information to a HTTP server;

receiving from the HTTP server the web page information and a monitoring script preset on the HTTP server; and

sending information related to URL in the received web page information to an analyzing server based on the monitoring script, where the analyzing server parses URL text information from the information related to the URL and determines whether the link layer hijacking occurs in the received web page information based on the URL text information.

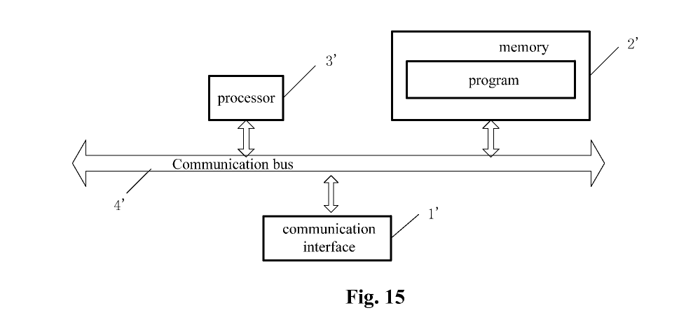

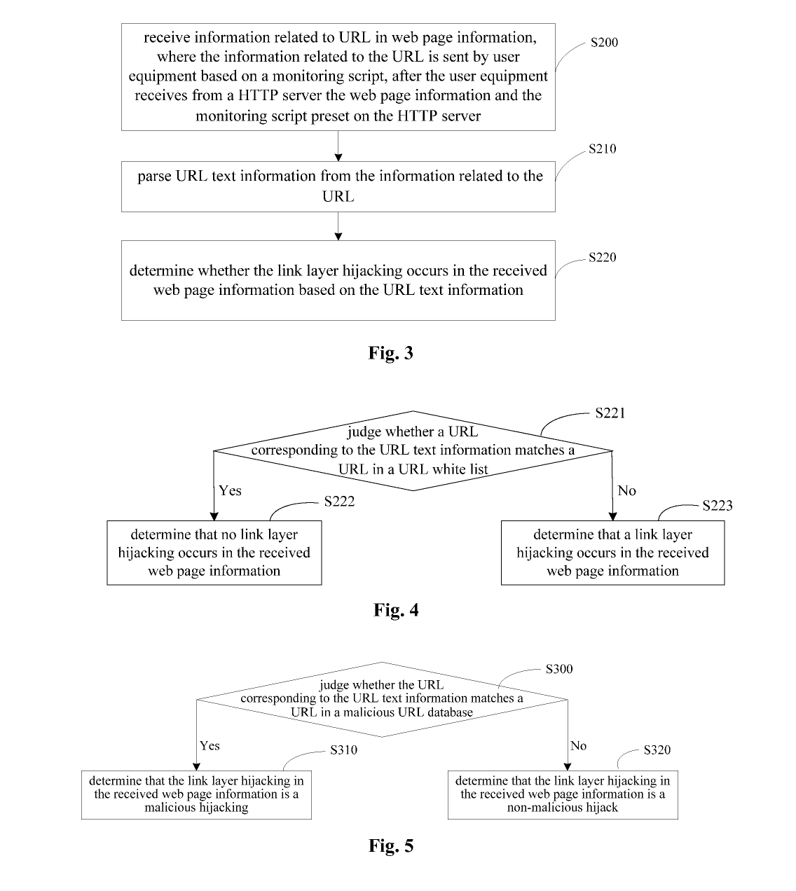

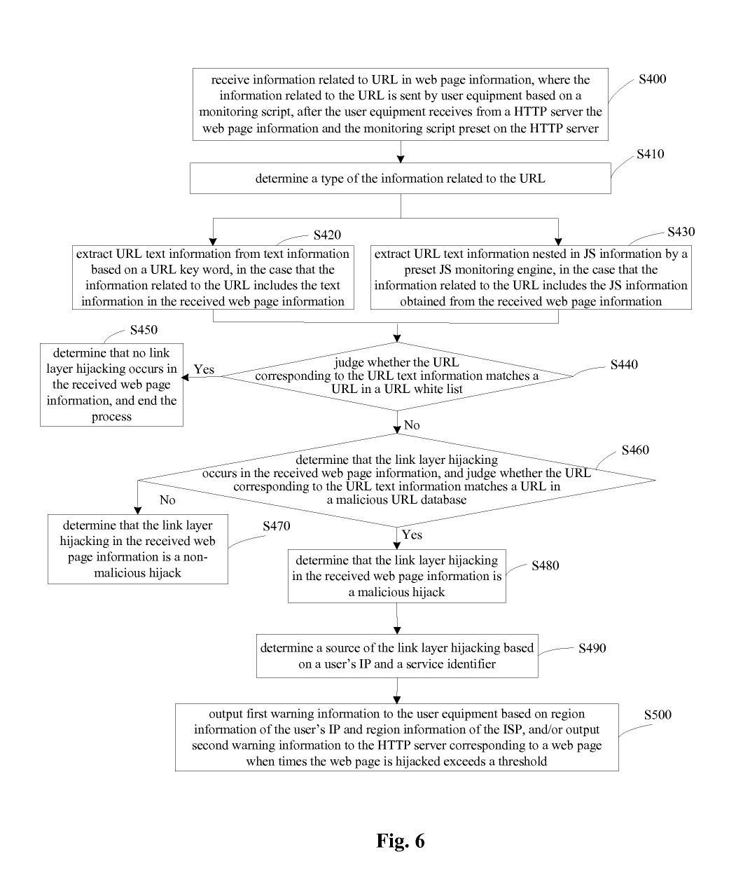

A hardware structure of an analyzing server will be described below according to embodiments of the disclosure. FIG. 15 is a diagram showing a hardware structure of an analyzing server according to embodiments of the disclosure. Referring to FIG. 15, the analyzing server may include a communication interface 1′, a memory 2′, a processor 3′ and a communication bus 4′.

The components of the analyzing server are described in detail by referring to FIG. 15.

A communication interface 1′ may be an interface of a communication module, such as an interface of a network card, which is configured to receive and transmit signals between an access server and peripheral equipment.

A memory 2′ may be configured to store software programs and modules. A processor 3′ performs various function applications and data processes in the access server by running the software programs and modules stored in the memory 2′. The memory 2′ may mainly include a storage region for program and a storage region for data. The storage region for program may store operating system, applications needed by at least one function (such as an audio playing function, a video playing function), and the like. The storage region for data may store data (such as video data, an address book) generated by using the access server, and the like. Furthermore, the memory 2′ may include a high speed random access memory and may further include a non-volatile storage, such as at least one of a disk storage device, a flash memory or other non-volatile solid-state storage device.

The processor 3′ is a control center of the access server, which is connected to various components of the access server through various interfaces and lines. The processor 3′ performs various functions and data processes by executing or running the software programs and modules stored in the memory 2′ and calling the data stored in the memory 2′, thereby monitoring the access server. Optionally, the process 3′ may include one or more processing unit. Preferably, an application processor and a modem may be integrated into the processor 3, in which the application processor is applied to the operating system and applications, and the modem is applied to a wireless communication. It can be understood that the above modem may further not be integrated into the process 3′.

The communication 1′, the memory 2′ and the processor 3′ communicate with each other through a communication bus 4′.

In embodiments of the disclosure, the processor 3 may further have the following functions:

receiving information related to URL in web page information, where the information related to the URL is sent by user equipment based on a monitoring script, after the user equipment receives from a HTTP server the web page information and the monitoring script preset on the HTTP server;

parsing URL text information from the information related to the URL; and

determining whether the link layer hijacking occurs in the received web page information based on the URL text information.

The embodiments of the disclosure are described herein in a progressive manner, with an emphasis placed on explaining the difference between each embodiment and the other embodiments; hence, for the same or similar parts among the embodiments, they can be referred to from one another. For the device and system disclosed in the embodiments, the corresponding descriptions are relatively simple because the device and system correspond to the methods disclosed in the embodiments. The relevant portions may be referred to the description for the method parts.

Those skilled in the art can further understand that the individual exemplary units and steps that are described in conjunction with the embodiment disclosed herein are able to be implemented in the electronic hardware, the computer software or a combination of both the electronic hardware and the computer software, and the components and the steps of the individual examples have been described according to the function generally in the above description, for describing the interchangeability between the hardware and the software clearly. Whether these functions are implemented in hardware or software is determined by the technical solution-specific application and the design constraint condition. For each specific application, the described function can be implemented by those skilled in the art using different method, but this implementation should not be considered as beyond the scope of the disclosure.

The steps of the method or the algorithm that are described in conjunction with the embodiment disclosed herein can be implemented by the hardware, the software module performed by the processor or the combination of both the hardware and the software module performed by the processor. The software module can be built in the Random Access Memory (RAM), the memory, the Read-Only Memory (ROM), the electrically programmable ROM, the electrically erasable programmable ROM, the register, the hardware, the movable disc, the CD-ROM, or any other forms of storing medium that is well-known in the technical field.

The description of the embodiments herein enables those skilled in the art to implement or use the present disclosure. Numerous modifications to the embodiments will be apparent to those skilled in the art, and the general principle herein can be implemented in other embodiments without deviation from the spirit or scope of the disclosure. Therefore, the disclosure will not be limited to the embodiments described herein, but in accordance with the widest scope consistent with the principle and novel features disclosed herein.

1. A method for detecting a link layer hijacking, comprising:
requesting, by a user equipment, web page information to a Hypertext Transfer Protocol (HTTP) server;
receiving, by the user equipment, from the HTTP server the web page information and a monitoring script preset on the HTTP server;
sending, to an analyzing server, information related to Uniform Resource Locator (URL) in the received web page information based on the monitoring script; and
parsing, by the analyzing server, URL text information from the information related to the URL, and determining, by the analyzing server, whether the link layer hijacking occurs in the received web page information based on the URL text information.

2. The method according to claim 1, wherein the information related to the URL comprises at least one of the following: text information in the received web page information and Java script information obtained from the received web page information.

3. The method according to claim 2, wherein parsing the URL text information from the information related to the URL comprises:
extracting, by the analyzing server, the URL text information from the text information based on a URL key word, in the case that the information related to the URL comprises the text information in the received web page information; and
extracting, by the analyzing server, the URL text information nested in the Java script information by using a preset Java script monitoring engine, in the case that the information related to the URL comprises the Java script information obtained from the received web page information.

4. A method for detecting a link layer hijacking, comprising:
receiving, by an analyzing server, information related to Uniform Resource Locator (URL) in web page information after user equipment receives the web page information and the monitoring script preset on a Hypertext Transfer Protocol (HTTP) server, wherein the information related to the URL is sent by the user equipment based on a monitoring script; parsing, by the analyzing server, URL text information from the information related to the URL; and
determining, by the analyzing server, whether the link layer hijacking occurs in the received web page information based on the URL text information.

5. The method according to claim 4, wherein the information related to the URL comprises at least one of the following: text information in the received web page information and Java script information obtained from the received web page information.

6. The method according to claim 5, wherein parsing URL text information from the information related to the URL comprises:
extracting the URL text information from the text information based on a URL key word, in the case that the information related to the URL comprises the text information in the received web page information; and
extracting the URL text information nested in the Java script information by a preset Java script monitoring engine, in the case that the information related to the URL comprises the Java script information obtained from the received web page information.

7. The method according to claim 6, wherein determining whether the link layer hijacking occurs in the received web page information based on the URL text information comprises:
determining whether a URL corresponding to the URL text information matches a URL in a URL white list; and
determining that the link layer hijacking occurs in the received web page information, in the case that the URL corresponding to the URL text information does not match any URLs in the URL white list.

8. The method according to claim 7, further comprising:
determining whether the URL corresponding to the URL text information matches a URL in a malicious URL database after determining that the link layer hijacking occurs in the received web page information; and
determining that the link layer hijacking in the received web page information is a malicious hijack, in the case that the URL corresponding to the URL text information matches a URL in the malicious URL database; and
determining that the link layer hijacking in the received web page information is a non-malicious hijack, in the case that the URL corresponding to the URL text information does not match any URLs in the malicious URL database.

9. The method according to claim 7, further comprising:
determining a source of the link layer hijacking based on a user's IP and a service identifier, after determining that the link layer hijacking occurs in the received web page information.

10. The method according to claim 7, further comprising:
outputting first warning information to the user equipment based on region information of the user's IP and region information of Internet Server Provider (ISP) after determining that the link layer hijacking occurs in the received web page information; or
outputting second warning information to the HTTP server corresponding to the web page, in the case that times the web page is hijacked exceeds a threshold.

11. The method according to claim 8, further comprising:
outputting first warning information to the user equipment based on region information of the user's IP and region information of Internet Server Provider (ISP) after determining that the link layer hijacking occurs in the received web page information; or
outputting second warning information to the HTTP server corresponding to the web page, in the case that times the web page is hijacked exceeds a threshold.

12. The method according to claim 9, further comprising:
outputting first warning information to the user equipment based on region information of the user's IP and region information of Internet Server Provider (ISP) after determining that the link layer hijacking occurs in the received web page information; or
outputting second warning information to the HTTP server corresponding to the web page, in the case that times the web page is hijacked exceeds a threshold.

13. A device for detecting a link layer hijack, wherein the device comprises a processor and a non-transitory storage accessible to the processor, the processor is configured to:
receive information related to Uniform Resource Locator (URL) in web page information, after user equipment receives from a Hypertext Transfer Protocol (HTTP) server the web page information and the monitoring script preset on the HTTP server, wherein the information related to the URL is sent by the user equipment based on a monitoring script;
parse URL text information from the information related to the URL; and
determine whether the link layer hijacking occurs in the received web page information based on the URL text information.

14. The device according to claim 13, wherein the information related to the URL comprises at least one of the following: text information in the received web page information and Java script information obtained from the received web page information.

15. The device according to claim 14, wherein the processor is further configured to:
extract the URL text information from the text information based on a URL key word, in the case that the information related to the URL comprises the text information in the received web page information; and
extract the URL text information nested in the Java script information by a preset Java script monitoring engine, in the case that the information related to the URL comprises the Java script information obtained from the received web page information.
